(19) United States
(12) Patent Application Publication
(10) Pub. No.: US 2026/0292792 A1
(43) Pub. Date: Sep. 24, 2026

(54) MEDIUM ACCESS CONTROL (MAC) METHODS AND PROCEDURES TO ENABLE TONE-DISTRIBUTED RESOURCE UNITS (TD-RUS)

(71) Applicant: InterDigital Patent Holdings, Inc., Wilmington, DE (US)

(72) Inventors: Mahmoud SAAD, Montreal (CA); Zinan LIN, Basking Ridge, NJ (US); Hanqing LOU, Syosset, NY (US); Xiaofei WANG, North Caldwell, NJ (US); Rui YANG, Melville, NY (US)

(73) Assignee: InterDigital Patent Holdings, Inc., Wilmington, DE (US)

(21) Appl. No.: 19/479,565

(22) PCT Filed: May 17, 2024
(86) PCT No.: PCT/US2024/029849

§ 371 Date: Oct. 28, 2025

Related U.S. Application Data
(60) Provisional application No. 63/467,164, filed on May 17, 2023.

(51) Int. Cl. H04W 72/044

(52) U.S. Cl. CPC H04W 72/044

(57) ABSTRACT

In a wireless local area network (WLAN), a station (STA) may receive a trigger frame including a user information field indicating a resource allocation for a tone distributed resource unit (TD-RU). Further, the STA may transmit a TD-RU transmission in the resource allocation based on the user information field indicating the resource allocation for the TD-RU. In an example, the TD-RU transmission may be a trigger based (TB) physical layer (PHY) protocol data unit (PDU) (TB-PPDU). In a further example, the user information field may be addressed to the STA. In another example, the user information field may include an RU allocation subfield. Moreover, the resource allocation for the TD-RU may be included in the RU allocation subfield, in an example. Also, the user information field may include indication information indicating one or more of an RU, multiple RUs (MRUs), or a TD-RU.

### CROSS-REFERENCE TO RELATED APPLICATION

This application claims the benefit of U.S. Provisional Application No. 63/467,164, filed May 17, 2023, the contents of which are incorporated herein by reference.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired network or wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP, and the AP delivers the traffic to the destination STA.

Using the 802.11ac infrastructure mode of operation, the AP may transmit a beacon on a fixed channel, usually the primary channel. This channel may be 20 megahertz (MHz) wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

### SUMMARY

Methods and procedures to enable tone-distributed resource unit (TD-RU) transmission and reception in a wireless local area network (WLAN) are disclosed. In a wireless local area network (WLAN), a station (STA) may receive a trigger frame including a user information field indicating a resource allocation for a tone distributed resource unit (TD-RU). Further, the STA may transmit a TD-RU transmission in the resource allocation based on the user information field indicating the resource allocation for the TD-RU. In an example, the TD-RU transmission may be a trigger based (TB) physical layer (PHY) protocol data unit (PDU) (TB-PPDU).

In a further example, the user information field may be addressed to the STA. In another example, the user information field may include an RU allocation subfield. Moreover, the resource allocation for the TD-RU may be included in the RU allocation subfield, in an example.

Additionally or alternatively, the user information field may include indication information indicating one or more of an RU or a multiple RU (MRU). Additionally or alternatively, the user information field may include indication information indicating one or more TD-RUs. Additionally or alternatively, the indication information may further indicate a first subchannel with a first bandwidth (BW) for at least one RU or MRU, and a second subchannel with a second BW for at least one TD-RU.

Additionally or alternatively, the STA may be a UHR STA. In an additional example, the STA may support TD-RUs. Additionally or alternatively, a TD-RU may be an RU whose subcarriers are spread over a certain bandwidth which is larger than the bandwidth effectively occupied by this RU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a frame format diagram illustrating an example of an high efficiency (HE) variant Common Info field format in a trigger frame;

FIG. 2B is a frame format diagram illustrating an example of an extremely high throughput (EHT) variant Common Info field format in a trigger frame;

FIG. 2C is a frame format diagram illustrating an example of a Special User Info field;

FIG. 3 is a frame format diagram illustrating an example of an HE variant User Info field format and an EHT variant Common Info field format in a trigger frame;

FIG. 4 is a transmission diagram illustrating an example of a modified beacon transmission to indicate a tone-distributed resource unit (TD-RU) available window;

FIG. 5 is an element diagram illustrating an example of a design of a TD-RU operation element;

FIG. 6 is a frame diagram illustrating an example of a design of a TD-RU announcement frame;

FIG. 7 is a field diagram illustrating an example of a design of a station (STA) Info List field in the TD-RU announcement frame;

FIG. 8 is an element diagram illustrating an example of a design of a TD-RU Delivery Indication (TD-RU DI) element;

FIG. 9 is a signaling diagram illustrating an example of resource allocation for one or more TD-RUs;

FIG. 10 is a channel diagram illustrating an example of a distribution of TD-RUs or TD-multiple RUs (MRUs) over an 80 megahertz (MHz) channel with two consecutive punctured 20 MHz subchannels;

FIG. 11 is a channel diagram illustrating an example of a distribution of TD-RUs or TD-MRUs over an 80 MHz channel with two non-contiguous non-punctured 20 MHz subchannels; and

FIG. 12 is a channel diagram illustrating an example of a distribution of TD-RUs or TD-MRUs over an 80 MHz channel with one punctured 20 MHz subchannel.

### DETAILED DESCRIPTION

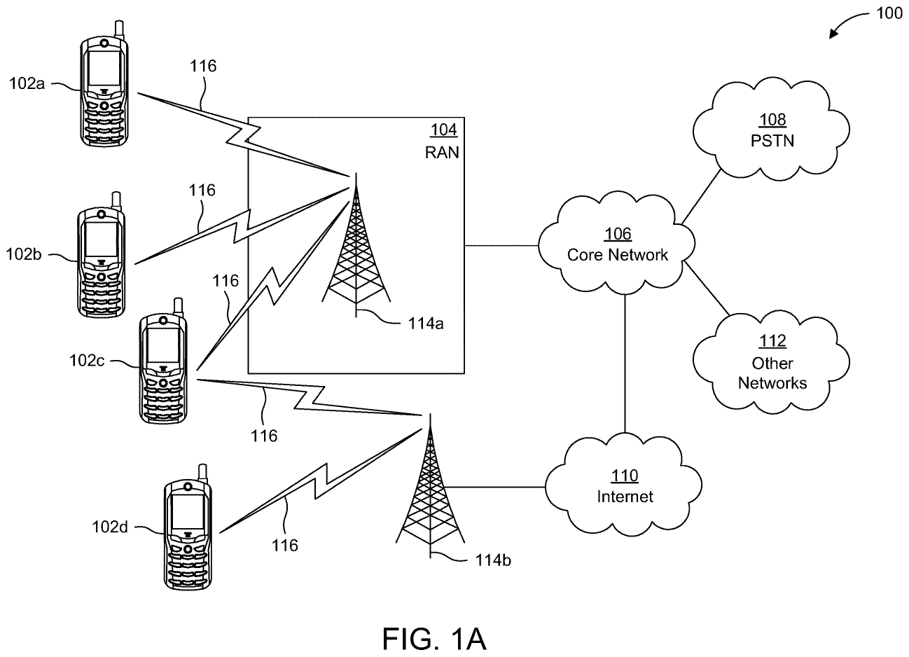

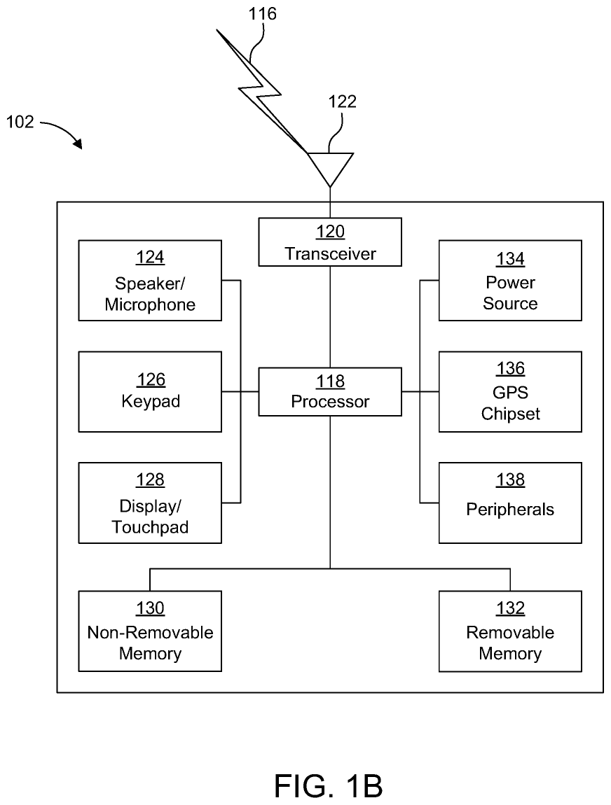

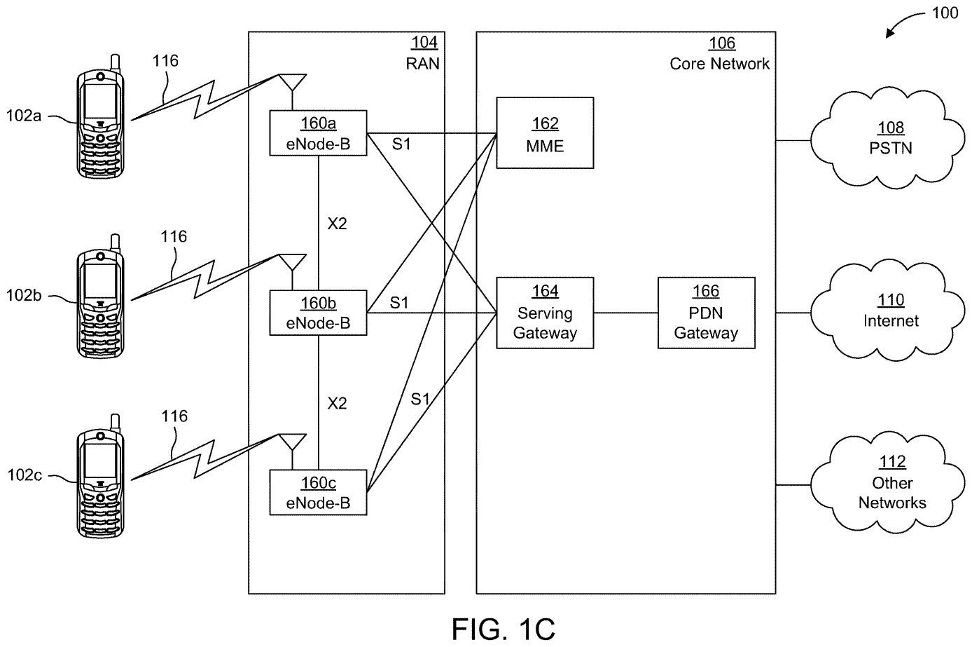

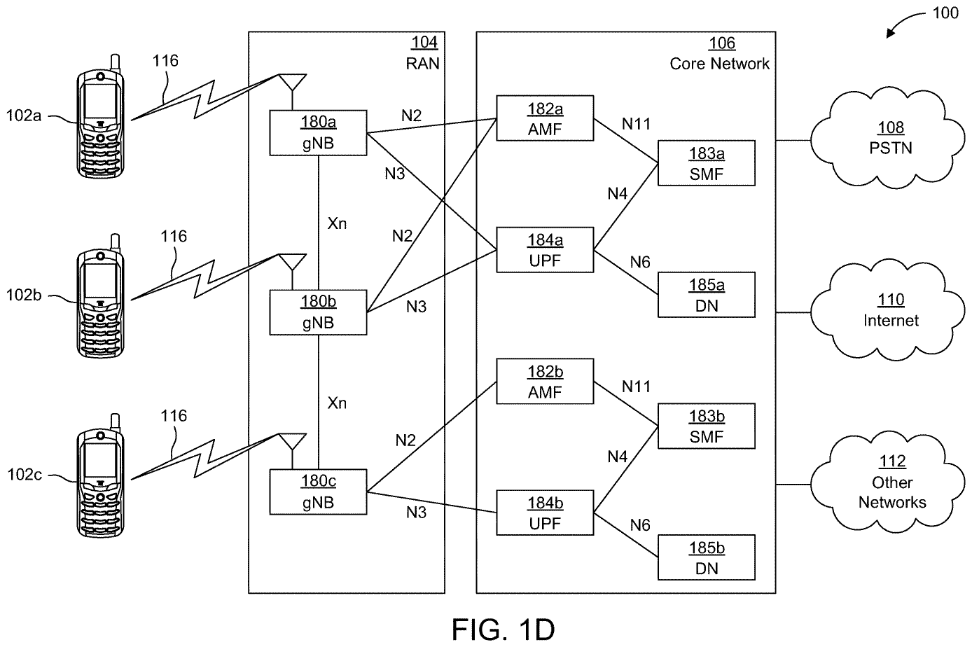

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (for example, radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (for example, an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (for example, for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (for example, WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (for example, the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (for example, the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (for example, multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (for example, a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (for example, nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (for example, longitude and latitude) regarding the current location of the WTRU 102. In addition to, or in lieu of, the information from the GPS chipset 136, the WTRU 102 may receive location information over the air interface 116 from a base station (for example, base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (for example, associated with particular subframes for both the UL (for example, for transmission) and DL (for example, for reception) may be concurrent and/or simultaneous. The full duplex radio may include an interference management unit to reduce and or substantially eliminate self-interference via either hardware (for example, a choke) or signal processing via a processor (for example, a separate processor (not shown) or via processor 118). In an embodiment, the WTRU 102 may include a half-duplex radio for which transmission and reception of some or all of the signals (for example, associated with particular subframes for either the UL (for example, for transmission) or the DL (for example, for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (for example, temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (for example, directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (for example, all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width, for example, 20 megahertz (MHz) wide bandwidth, or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (for example, every STA), including the AP, may sense the primary channel. If the primary channel is sensed/detected and/or determined to be busy by a particular STA, the particular STA may back off. One STA (for example, only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 gigahertz (GHz) modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (for example, only support for) certain and/or limited bandwidths. The MTC devices may include a battery with a battery life above a threshold (for example, to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (for example, MTC type devices) that support (for example, only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (for example, containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (for example, such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (for example, handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (for example, an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (for example, testing) wired and/or wireless communication network in order to implement testing of one or more components. The one or more emulation devices may be test equipment. Direct RF coupling and/or wireless communications via RF circuitry (for example, which may include one or more antennas) may be used by the emulation devices to transmit and/or receive data.

In 802.11n, HT STAs may also use a 40 MHz wide channel for communication. This is achieved by combining the primary 20 MHz channel, with an adjacent 20 MHz channel to form a 40 MHz wide contiguous channel.

In 802.11ac, VHT STAs may support 20 MHz, 40 MHz, 80 MHz, and 160 MHz wide channels. The 40 MHz, and 80 MHz, channels are formed by combining contiguous 20 MHz channels similar to 802.11n described above. A 160 MHz channel may be formed either by combining 8 contiguous 20 MHz channels, or by combining two non-contiguous 80 MHz channels, which may also be referred to as an 80+80 configuration. For the 80+80 configuration, the data, after channel encoding, is passed through a segment parser that divides it into two streams. The Inverse Discrete Fourier Transformation (IDFT) operation and time-domain processing is done on each stream separately. The streams are then mapped on to the two channels, and the data is transmitted. At the receiver, this mechanism is reversed, and the combined data is sent to the MAC.

To improve spectral efficiency 802.11ac has introduced the concept for downlink Multi-User MIMO (MU-MIMO) transmission to multiple STAs in the same symbol's time frame, for example, during a downlink OFDM symbol. The potential for the use of downlink MU-MIMO is also currently considered for 802.11ah. It is important to note that since downlink MU-MIMO, as it is used in 802.11ac, uses the same symbol timing to multiple STAs, interference of the waveform transmissions to multiple STAs is not an issue. However, all STAs involved in MU-MIMO transmission with the AP must use the same channel or band, and this limits the operating bandwidth to the smallest channel bandwidth that is supported by the STAs which are included in the MU-MIMO transmission with the AP.

IEEE 802.11 ultra high reliability (UHR) modifications include improved reliability of WLAN connectivity, reduced latencies, increased manageability, and increased throughput. Several modified features are proposed, including the following. UHR may support a maximum aggregated throughput of at least 100 gigabits per second (Gbps). Also, UHR may support at least two times improvement in aggregated throughput at every signal to noise ratio (SNR) level (measured at the MAC data service access point) compared to 802.11be. Further, UHR may define at least one mode of operation capable of improved latency bound and jitter at the 99th to 99.9999th percentiles compared to 802.11be.

Moreover, UHR may support satisfying real-time applications requirements for high reliability in the presence of overlapping BSSs and for seamless BSS transitions within an extended service set (ESS). Additionally, UHR may support enabling backward compatibility and coexistence with legacy IEEE 802.11 devices operating in license-exempt bands between 1 GHz and 7.250 GHZ, and enabling coexistence with legacy IEEE 802.11 devices operating in license-exempt bands between 42.5 GHZ and 71 GHZ.

Trigger frame was introduced firstly in 802.11ax. Extremely high throughput (EHT) supports greater bandwidth (BW), multiple resource unit (RU) allocation, an enhanced modulation and coding scheme (MCS), and a greater number of spatial streams. 802.11be modified the Trigger frame so that it supports 802.11be new features, and meanwhile is backward compatible with 802.11ax. The trigger frame is used to allocate resources, and trigger single user access or multi-user access. A trigger frame format defined in 802.11ax is shown in Table 1, below. 802.11be reuses the same format for the Trigger frame.

TABLE 1
Trigger frame format in 802.11ax

| | | | | | | | | | | |
|---|---|---|---|---|---|---|---|---|---|---|
| | Frame | | | | Common | | | | | |
| Field: | Control | Duration | RA | TA | Info | User Info | . . . | User Info | Padding | FCS |

| | | | | | | | | | |
|---|---|---|---|---|---|---|---|---|---|
| Octets: | 2 | 2 | 6 | 6 | 8 or more | 5 or more | 5 or more | V | 4 |

The Common Info field in 802.11be has two variants, the high efficiency (HE) variant and the EHT variant.

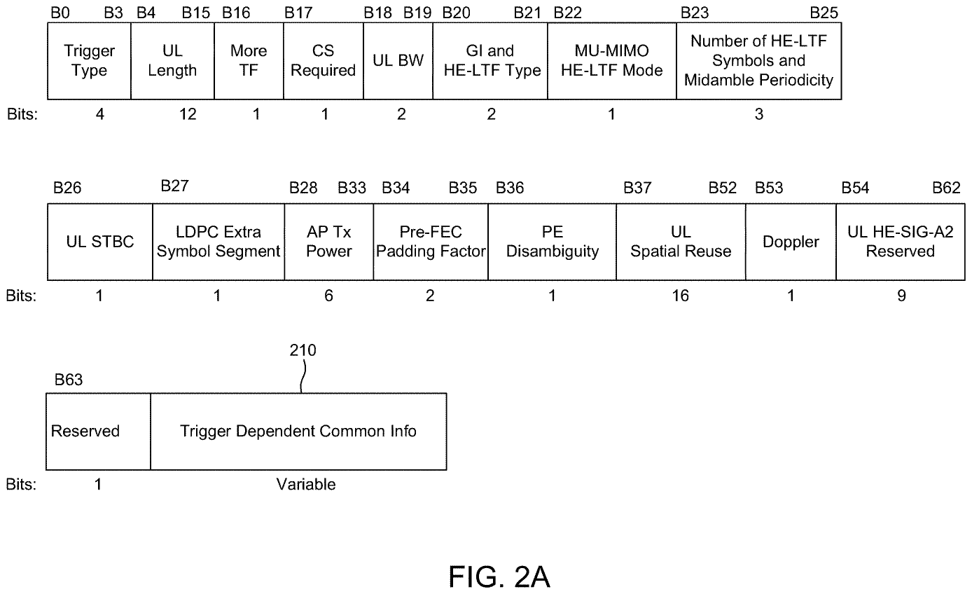

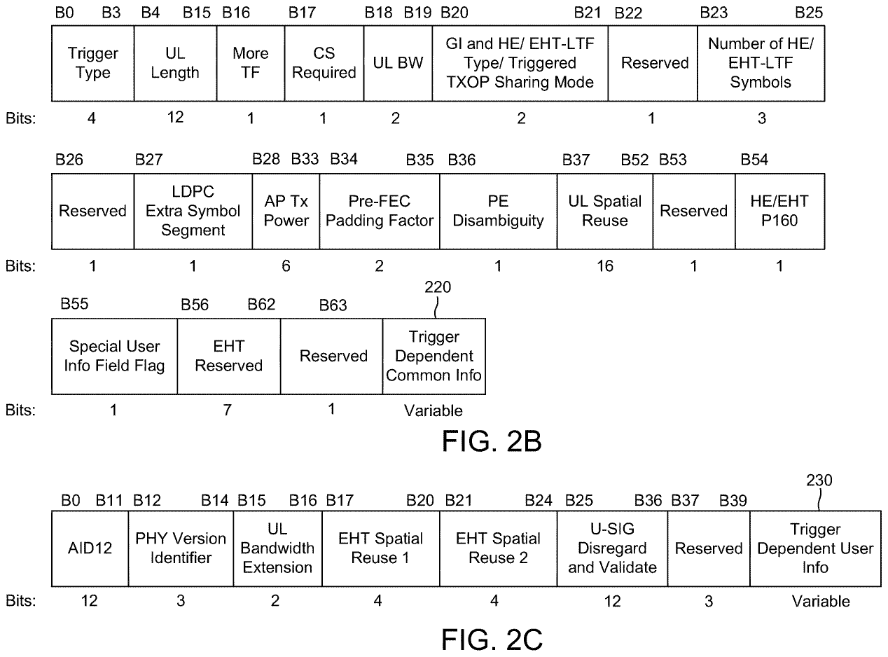

FIG. 2A is a frame format diagram illustrating an example of an HE variant Common Info field format in a trigger frame. As shown in an example in FIG. 2A, the Trigger Dependent Common Info subfield 210 may be of variable bit length. The bit lengths of the other subfields in the HE variant Common Info field format may be as shown in FIG. 2A.

FIG. 2B is a frame format diagram illustrating an example of an EHT variant Common Info field format in a trigger frame. As shown in an example in FIG. 2B, the Trigger Dependent Common Info subfield 220 may be of variable bit length. The bit lengths of the other subfields in the EHT variant Common Info field format may be as shown in FIG. 2B.

Further, there are three types of User Info fields defined in 802.11be: the Special User Info field, the HE variant User Info field and the EHT variant User Info field. The Special User Info field carries extended common information for EHT STAs to transmit a EHT trigger based (TB) physical layer (PHY) PDU (PPDU) (TB-PPDU).

FIG. 2C is a frame format diagram illustrating an example of a Special User Info field. As shown in an example in FIG. 2C, the Trigger Dependent User Info subfield 230 may be of variable bit length. The bit lengths of the other subfields in the Special User Info field may be as shown in FIG. 2C.

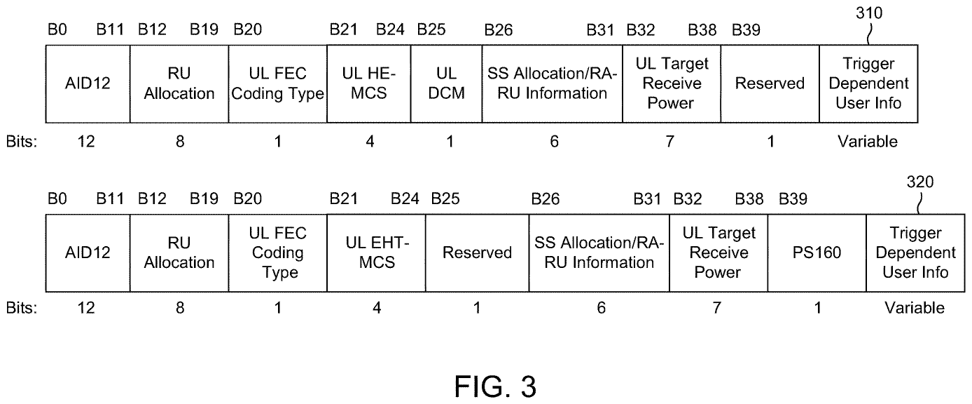

FIG. 3 is a frame format diagram illustrating an example of an HE variant User Info field format and an EHT variant Common Info field format in a trigger frame. The HE variant User Info field for all trigger types except Null Feedback Report Poll (NFRP) trigger is defined in the top part of FIG. 3. As shown in an example in FIG. 3, the Trigger Dependent User Info subfield 310 of the HE variant User Info field format may be of variable length. The bit lengths of the other subfields in the HE variant User Info field format may be as shown in FIG. 3.

Also, the EHT variant User Info field for all trigger types except NFRP trigger is defined in the bottom part of FIG. 3. As shown in an example in FIG. 3, the Trigger Dependent User Info subfield 320 of the EHT variant User Info field format may be of variable length. The bit lengths of the other subfields in the EHT variant User Info field format may be as shown in FIG. 3.

The trigger type subfield in Common Info field (such as in FIG. 2A or FIG. 2B), in the trigger frame format shown in Table 1, has possible values as shown in Table 2, below.

TABLE 2
Trigger Type

| Trigger Type Subfield value | Trigger frame variant |
|---|---|
| 0 | Basic |
| 1 | BF Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8-15 | Reserved |

Embodiments and examples are provided herein of methods of beacon transmission over tone-distributed (TD)-RUs. In current WLAN operation, TD-RU transmission is not defined. One approach may require an AP to determine a period to allow TD-RU transmission to avoid additional interference to other BSSs or the incumbent users. In addition, it may be desirable to design a specialized beacon to deliver the TD-RU related system information to the STAs which support TD-RU transmission, which would be beneficial to the STAs that are out of reach or out of range of the legacy beacon.

Embodiments and examples are provided herein of a trigger frame design to enable resource allocation of TD-RUs. Some uplink transmissions may be triggered by an AP. In this case, the AP may transmit a Trigger frame and include resource allocation information for the non-AP STAs to use for the trigger-based transmissions. The trigger frame needs to be modified to carry TD-RU allocation information so that STAs can use TD-RUs.

Embodiments and examples are provided herein of methods to enable TD-RUs with puncturing. An RU may refer to one or more subcarriers used in DL and UL transmissions. Also, a tone may refer to one subcarrier used in DL or UL transmission. A TD-RU is an RU whose subcarriers are spread over a certain bandwidth which is larger than the bandwidth effectively occupied by this RU. The effective bandwidth of an RU equals N×Δfₛ where N is the number of tones of the RU and Δfₛ is the subcarrier spacing. In WLAN, range extension can be achieved by distributing the tones of an RU over a wider bandwidth which allows for higher transmit power for each individual tone. The new resource unit may be named a TD-RU. A portion of bandwidth, such as one or more subcarriers, may be effectively occupied if that portion carries a tone. In examples, one or more subcarriers of a TD-RU may be separated from each other by a portion of empty bandwidth, or bandwidth not used for a tone or transmission. Further, a TD-RU may also be referred to as a distributed-tone RU (DRU) or a distributed RU, and still be consistent with the embodiments and example provided herein. Distributing regular RUs over a wider channel bandwidth which contains punctured subchannels requires flexible design of the TD-RUs to accommodate different puncturing patterns. Enabling TD-RUs with puncturing in WLAN is an open problem. This problem is addressed by embodiments and examples provided herein.

In a specific example, provided herein are methods of beacon transmission over TD-RUs. Examples include a procedure of enabling a TD-RU transmission mode. In an example, an AP or AP multi-link device (MLD) may provide support for accepting the transmission using TD-RUs and/or using TD-RU to perform DL transmission in its BSS or in the BSS for one of its affiliated APs.

An AP (or non-AP STA) may indicate that it supports TD-RU or TD-multiple RU (MRU) transmission and/or reception by setting a bit, for example, a TD-RU Support bit, in the capability element, for example, an HT Capabilities element, VHT Capabilities element, HE Capabilities element (in the HE MAC Capabilities Information field and/or HE PHY Capabilities Information field), EHT Capabilities element (in the EHT MAC Capabilities Information field and/or EHT PHY Capabilities Information field), UHR Capabilities element, Extended Capabilities element, or any other capability element. For example, if the TD-RU Support bit is set to 1, it may imply that the AP may support receiving the transmission using a TD-RU mode and/or use TD-RU for transmission. This element may be included in the beacon that the AP transmits. This element may be also included in other control or management frames that the AP transmits, for example, a short beacon frame, FILS discovery frame, TD-RU announcement frame, or the like. One of ordinary skill in the art would understand that the capabilities element may be transmitted in a format known in the art.

Additionally or alternatively, an AP may use two bits, for example, TD-RU Support bits, to indicate it supports TD-RU transmission, TD-RU reception, or both. These two bits may be included in the capability element, for example, an EHT Capabilities element (in the EHT MAC Capabilities Information field and/or EHT PHY Capabilities Information field), UHR Capabilities element, Extended Capabilities element, or any other capability element. For example, if TD-RU Support bits are set to 00, it implies that the AP does not support TD-RU transmission and reception; if TD-RU Support bits are set to 01, it implies that the AP only supports TD-RU reception but do not support the transmission with TD-RU; if TD-RU Supports bits are set to 10, it implies that the AP only supports the transmission using TD-RU but do not support to receive the transmission using TD-RU; and if TR-RU Support bits are set to 11, it implies that the AP supports the transmission using TD-RU and the reception of the transmission using TD-RU.

An AP may define a TD-RU available window, during which TD-RU transmission is allowed. An AP may include one TD-RU Available Window bit in the beacon or any other type of management frame or control frame to enable or disable the TD-RU operation. For example, if this bit is set to 1, it means TD-RU enabling window is initiated and TD-RU mode transmission/reception is allowed; otherwise, TD-RU mode is not allowed. In an alternative example, if this bit is set to 0, it means TD-RU enabling window is initiated and TD-RU mode transmission/reception is allowed; otherwise, TD-RU mode is not allowed. The duration of a TD-RU available window may be set in the TD-RU Duration field which may be carried by the beacon frame, TD-RU announcement frame, short beacon frame, FILS discovery frame, Probe Response frame, or any other type of management frame. For example, the frame may include a duration value for the duration of the TD-RU available window. The duration value may be same or different from the beacon duration.

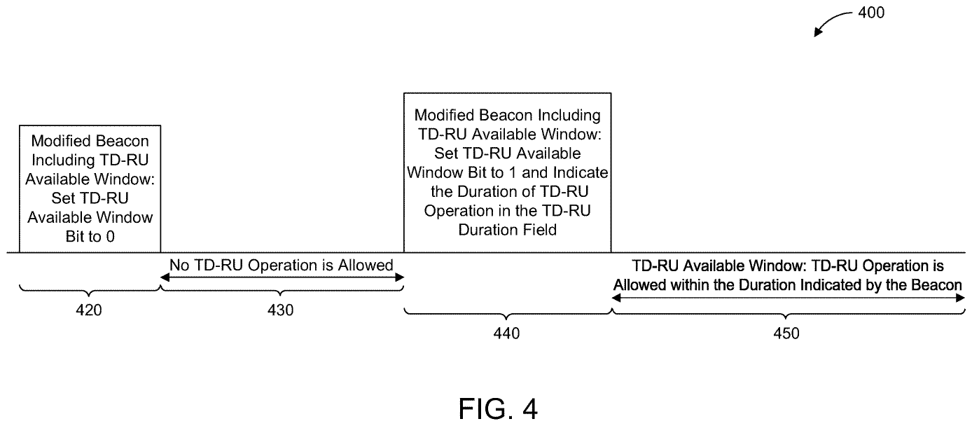

FIG. 4 is a transmission diagram illustrating an example of a modified beacon transmission to indicate a TD-RU available window. In an example shown in transmission diagram 400, an AP may set a TD-RU Available Window bit which is included in the beacon to 0 420. Such a setting implies that no TD-RU operation is allowed until further notification 430. After a while 430, another beacon may be transmitted by the AP which sets the TD-RU Available Window bit to 1, and indicates the duration of TD-RU operation in the Duration of TD-RU Operation field 440. All non-AP STAs which are associated with this AP may need to follow the command.

Additionally, if an AP sets the TD-RU Available Window to 0, which implies no TD-RU operation is allowed, the AP may also set the TD-RU Duration field to a duration value. This setting implies that no TD-RU operation is allowed during the duration value set in the TD-RU Duration field 450. In an alternative example, if an AP sets the TD-RU Available Window to 1, which implies no TD-RU operation is allowed, the AP may also set the TD-RU Duration field to a duration value.

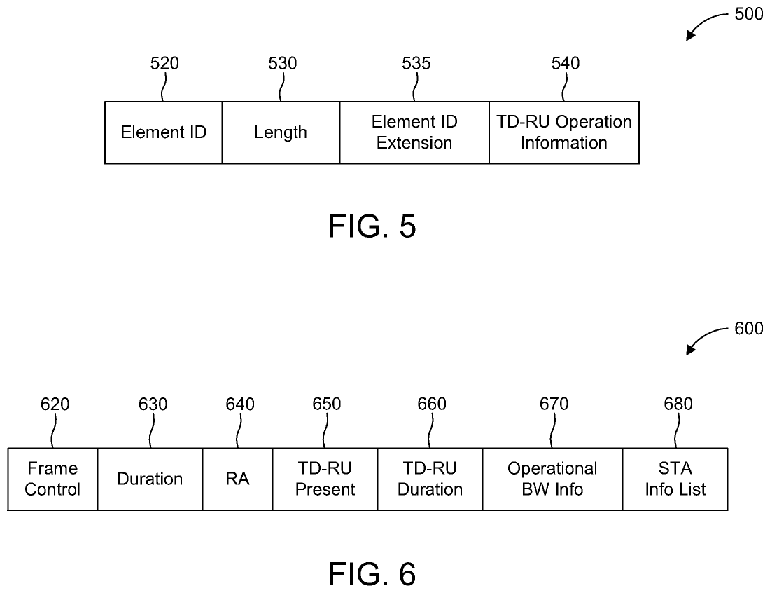

FIG. 5 is an element diagram illustrating an example of a design of a TD-RU operation element. As shown in an example in element diagram 500, the TD-RU Operation element may contain one or more fields as indicated in the following. The TD-RU Operation element may contain an element identity (ID) field 520 and element ID extension field 535. For example, the combination of the Element ID field 520 and the Element ID extension field 535 may indicate that the current element is a TD-RU operation element.

Also, the TD-RU Operation element may contain a Length field 530. This field may indicate the number of octets in the element excluding the Element ID 520 and Length fields 530.

Further, the TD-RU Operation element may contain a TD-RU Operation Information field 540. This field may include one or more following pieces of information. The TD-RU Operation Information field 540 may include TD-RU control information, which may indicate if the TD-RU is enabled or not enabled in a coming beacon interval. For example, if the TD-RU control information is set to 1, the TD-RU control information may imply that the TD-RU operation is enabled, and all remaining subfields with the TD-RU Operation Information field 540 are present. If the TD-RU control information is not set to 1, it may imply that the TD-RU operation is disabled, and all remaining subfields in the TD-RU Operation Information field 540 are reserved or not present.

The TD-RU Operation Information field 540 may include TD-RU operation bandwidth information, which may indicate the operational bandwidth used for TD-RU operation. Further, the TD-RU Operation Information field 540 may include TD-RU operation channel(s) information, which may indicate the operational channel(s) used for TD-RU operation. Additionally or alternatively, TD-RU operation channel(s) may also refer to the operational link(s) used for TD-RU operation. Also, the TD-RU Operation Information field 540 may include TD-RU operation duration information, which may indicate the duration used for TD-RU operation. In addition, the TD-RU Operation Information field 540 may include TD-RU transmit power limit information, which may indicate the maximum transmit power used for a non-AP STA in the TD-RU operation. Moreover, the TD-RU Operation Information field 540 may include TD-RU power spectrum density (PSD) limit information, which may indicate the PSD limit during TD-RU operation. Additionally, the TD-RU Operation Information field 540 may include the maximum number of STAs using TD-RU operation, which may indicate the maximum number of STAs which may use TD-RU transmission simultaneously.

To notify STAs of a TD-RU operation, an AP may send an enhanced beacon which include the TD-RU Operation element, for example, using the example design depicted in FIG. 5.

In an example, an AP may also transmit a TD-RU announcement frame, which may be a control frame or a management frame, to enable the TD-RU operation mode.

FIG. 6 is a frame diagram illustrating an example of a design of a TD-RU announcement frame. The following information may be included in the announcement frame, as shown in frame diagram 600. A TD-RU present field 650 may be included, which may contain only one bit, in an example. For example, if the TD-RU present field 650 is set to 1, the TD-RU present field 650 may imply that TD-RU operation of STAs which support TD-RU operation is allowed after a TD-RU announcement frame is set. If, the TD-RU present field 650 is not set to 1, the TD-RU present field 650 may imply that TD-RU operation is not allowed and all the remaining fields may be reserved, in an example.

Further, the TD-RU announcement frame may include an duration of TD-RU operation field 660, which may indicate the duration of TD-RU operation, which may start after the end of TD-RU Announcement frame. In addition, the TD-RU announcement frame may include an Operational BW Info field 670, which may indicate the channel(s), or subchannel(s), allowed for TD-RU operation. Also, the TD-RU announcement frame may include a STA Info List field 680, which may include the requirement for each STA or a group of STAs which are allowed to perform TD-RU transmission, TD-RU reception, or both. Further, the TD-RU announcement frame may include fields which are already included in trigger frames currently in use, such as a frame control field 620, a duration field 630 and a receiver address (RA) field 640.

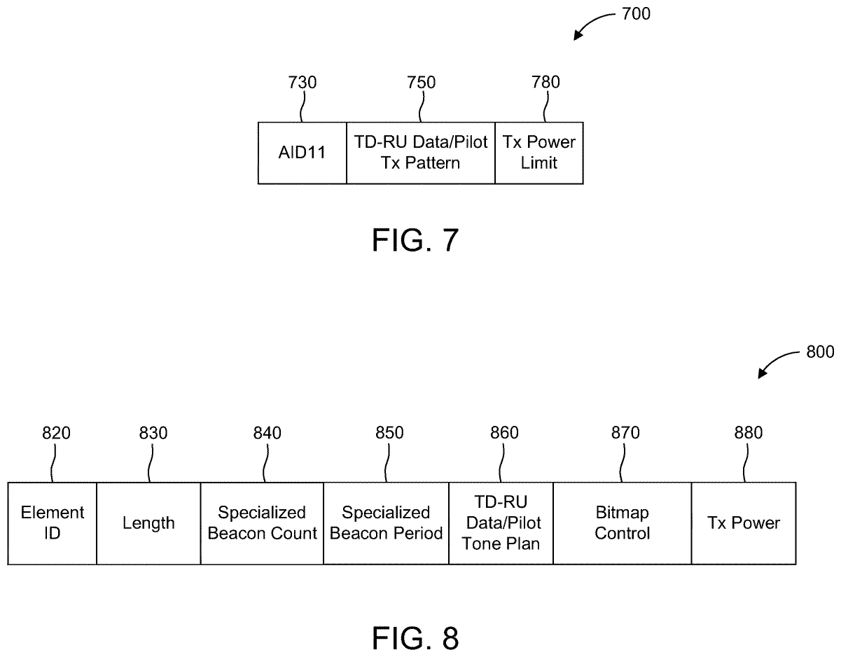

FIG. 7 is a field diagram illustrating an example of a design of a STA Info List field in the TD-RU announcement frame. As shown in an example in field diagram 700, the following information may be included in the STA Info List field, which may be or may correspond to the STA Info List field 680 of FIG. 6. An AID11 subfield 730 may be included, which may indicate the association ID (AID) of a STA or AIDs of a group of STAs which support TD-RU operation. The STA Info List field 680 may also include a TD-RU Data/Pilot Tx Pattern subfield 750 for a transmission (Tx) pattern, which may indicate an indication of the allocation pattern of TD-RU data and pilot tones used for the target STA whose AIDs are given in the AID 11 subfield 730 or the target group of STAs whose IDs are given in AID 11. An example of this indication may be an index which is mapped to a predefined TD-RU data and/or pilot tone allocation pattern. Further, the STA Info List field may include a Tx Power Limit subfield 780, which may indicate the transmit power limit and/or PSD limit allowed for TD-RU operations for the target STA whose AIDs are given in AID11 subfield 730 or the target group of STAs whose IDs are given in AID11.

In an example, an AP may transmit a specialized beacon and deliver it to the STAs that are out of communication range of the regular beacon and support TD-RU operations. This specialized beacon may use a TD-RU transmission mode. The preamble of the PPDU carrying this specialized beacon may indicate the Data and/or pilot tones plan used for the delivery of this specialized beacon.

In an example, an element, called a TD-RU Delivery Indication (TD-RU DI) element, may be included in this specialized beacon. This element may be used to deliver the system information to the STAs which are out of communication range of the regular beacons and support TD-RU operation.

FIG. 8 is an element diagram illustrating an example of a design of a TD-RU DI element. As shown in an example in FIG. 8, the Specialized Beacon Count field 840 may indicate how many Beacons frames appear before the next specialized beacon. The Specialized Beacon Period field 850 may indicate the number of beacon intervals or short beacon intervals between successive specialized beacons. Additionally or alternatively, the field may indicate the specialized beacon interval. Further, the TD-RU Data/Pilot Tone Plan field 860 may indicate one or more candidates of data and/or pilot tone plans used for TD-RU transmission, for example, between non-AP STAs and an AP or between STAs. Also, the Tx Power field 880 may indicate the transmit power used for this beacon transmission. Moreover, the Bitmap Control field 870 may indicate the target STAs which receive this beacon. Moreover, the element may include an element ID field 820 and a length field 830. Further, this specialized beacon may carry other information included in the regular beacon frame.

To minimize the interference, for example, inter-tone interference, such as interference to the incumbent users in the low power indoor band at 6 GHZ, the STAs that employ TD-RU transmission may not boost the power to the maximum such that their total transmit power is lower than the legacy one. Furthermore, if the STAs that employ the TD-RU transmission do not occupy the whole bandwidth, then the received signal strength over the whole bandwidth (for example, 20 MHz) may be lower than the legacy case. Therefore, there is a need to define a new clear channel assessment (CCA) sensitivity in the case where TD-RU operation is enabled.

In an example, the new CCA sensitivity level for TD-RU operation may be defined as follows. In the case where the TD-RU operation is enabled, the receiver may issue a PHY-CCA indication primitive with the STATUS parameter set to BUSY for any signal that exceeds the threshold below in the primary 20 MHz channel within a period of aCCATime after the signal arrives at the receiver's one or more antennas. In an example, a threshold value specified by a dot11MSDOFDMEDthreshold (a new value may need to be defined, for example, lower than −72 dBm) if any MediumSyncDelay timer at that STA has not expired. The threshold value may be X dBm otherwise, where X dBm may be smaller than −62 dBm, for example. The threshold value of X dBm may be included in the beacon frame and/or the specialized beacon frame that are defined elsewhere herein.

In the case where the TD-RU operation is enabled, if the operating channel width is greater than 20 MHz and the PHY issues a PHY-CCA indication primitive, the PHY shall set the per20bitmap to indicate the busy/idle status of each 20 MHz subchannel. A 20 MHz subchannel is busy if at least one of the following conditions is present. A condition may be that a signal is present on the 20 MHz subchannel at or above a threshold of x dBm at the receiver's antenna(s). The x dBm may be different from −62 dBm, for example, may be smaller than −62 dBm. Another condition may be that a non-HT, HT_MF, HT_GF, VHT, HE, or EHT PPDY for which the power measured within this 20 MHz subchannel is at or above max (y, OBSS_PD_level) at the receivers antenna(s). y may be different from −72 dBm, for example, may be smaller than −72 dBm. The values of x and y may be included in the beacon frame and/or the specialized beacon frame that is defined elsewhere herein.

Examples are provided herein of trigger frame design to enable resource allocation of TD-RUs. In an example method, the Trigger frame may reuse the Trigger frame designed originally in 802.11ax, and modifications are applied to fulfill the UHR use cases. A Trigger frame which is not an MU-request to send (MU-RTS) Trigger frame may allocate resources to solicit one or more Trigger Based PPDU (TB PPDU) transmissions. The TB PPDU here may be one or more of an HE TB PPDU, EHT TB PPDU, or UHR TB PPDU. The Trigger frame format may follow the 802.11ax Trigger frame format as shown in Table 3, below.

TABLE 3
Trigger frame defined in 802.11ax

| | | | | | | | | | |
|---|---|---|---|---|---|---|---|---|---|
| Frame | Duration | RA | TA | Common | User | . . . | User Info | Padding | FCS |
| Control | | | | Info | Info | | | | |

In an example method, the Trigger frame may have an HE variant, EHT variant and UHR variant. There may be different variants for the User Info field. A variant of the User Info field may be a Special User Info field, which is defined in 802.11be. The PHY Version Identifier may indicate the PHY Version. One value may be used to indicate the PHY Version is UHR.

Another variant of the User Info field may be an HE variant User Info field. The HE variant User Info field is defined in 802.11be.

A further variant of the User Info field may be an EHT variant User Info field, which is also defined in 802.11be. This EHT variant User Info field may be reused to carry information for both EHT and UHR STAs. An RU Allocation subfield may be carried in this field and some values may be used to indicate TD-RU allocations.

An additional variant of the User Info field may be a UHR Special User Info field, which may be used to carry extended common information that not provided in the Common Info field and/or Special User Info field. An AID subfield may be carried in the UHR Special User Info field. A special value of AID subfield may indicate the User Info field is an UHR Special User Info field. By doing so, an AP may not assign that AID value to any STAs. It may be appreciated that extended common information associated with TD-RU allocations may be accordingly included in a Common Info field, a Special User Info field, or both, of future generation 802.11 control frames beyond UHR.

Also, a variant of the User Info field may be a UHR variant User Info field, which may be newly defined to carry information for UHR STAs. An RU Allocation subfield may be carried in this field and some values may be used to indicate TD-RU allocations.

An RU Allocation subfield is included in the Trigger frame to indicate the size and location of the RU, MRU and TD-RU which has been assigned for a recipient for TB PPDU transmission, in an example. In an example method, one or more bits in the RU Allocation subfield, or a combination of the RU Allocation subfield and another subfield, may be used to indicate the segment in which the RU/MRU/TD-RU is located. The segment here refers to a subchannel with fixed size, for example, an 80 MHz subchannel, a 160 MHz subchannel and the like. For example, when the bandwidth is 640 MHz, 3 bits may be used to indicate the location of an 80 MHz segment. In one example, there is a subfield defined as a Segment Indication subfield which carries the 3 bits. In one example, the 3 bits may be carried in the RU Allocation subfield. In an example, part of the 3 bits may be carried in the RU Allocation subfield and part of the 3 bits may be carried in another subfield.

In an example method, one bit in the RU Allocation subfield may be used to indicate if the RU is an RU/MRU or a TD-RU. In one method, the combination of several bits in the RU Allocation subfield may be used to indicate if the RU is an RU/MRU or a TD-RU. A table lookup method may be used in the RU Allocation subfield to identify an RU/MRU/TD-RU.

Table 4, below, gives an example of encoding of RU Allocation subfields in the Trigger frame. The example uses Bit 0 of the RU Allocation subfield to indicate whether the allocation is an RU/MRU or TD-RU as an example, and one or more other bit positions may be used for this purpose, additionally or alternatively. The example uses Bit 1 to Bit x of the RU Allocation subfield to indicate the RU/MRU/TD-RU index within an 80 MHz subchannel as an example, and one or more other bit positions may be used for this purpose, additionally or alternatively. Further, the example uses an assumption that RUs and TD-RUs with the same size may be given the RU index together. For example, the localized 26-tone RUs are given indices from RU1 to RU37; and the distributed 26-tone RUs are given indices from RU38 to RU74. The localized 52-tone RUs are given indices from RU1 to RU16; and the distributed 52-tone RUs are given indices from RU17 to RU32. The localized 106-tone RUs are given indices from RU1 to RU4; and the distributed 106-tone RUs are given indices from RU5 to RU8.

TABLE 4
Example of an encoding of an RU Allocation subfield

| | Bit 1-Bit x of | | |
|---|---|---|---|
| Bit 0 of the RU | the RU | | |
| Allocation | Allocation | RU/MRU/TD-RU | RU/MRU/TD-RU |
| subfield | subfield | size | index |
| 0 | 0-8 | 26 | RU1 to RU9 |
| 0 | 9-17 | 26 | RU10 to RU18 |
| 0 | 19-36 | 26 | RU20 to RU37 |
| 1 | 0-8 | 26 | RU38 to RU46 |
| 1 | 9-17 | 26 | RU47 to RU55 |
| 1 | 19-36 | 26 | RU57 to RU74 |
| 0 | 37-40 | 52 | RU1 to RU4 |
| 0 | 41-44 | 52 | RU5 to RU8 |
| 0 | 45-52 | 52 | RU9 to RU16 |
| 1 | 37-40 | 52 | RU17 to RU20 |
| 1 | 41-44 | 52 | RU21 to RU24 |
| 1 | 45-52 | 52 | RU25 to RU32 |
| 0 | 53, 54 | 106 | RU1 and RU2 |
| 0 | 55, 56 | 106 | RU3 and RU4 |
| 1 | 53, 54 | 106 | RU5 and RU6 |
| 1 | 55, 56 | 106 | RU7 and RU8 |
| . . . | . . . | . . . | . . . |

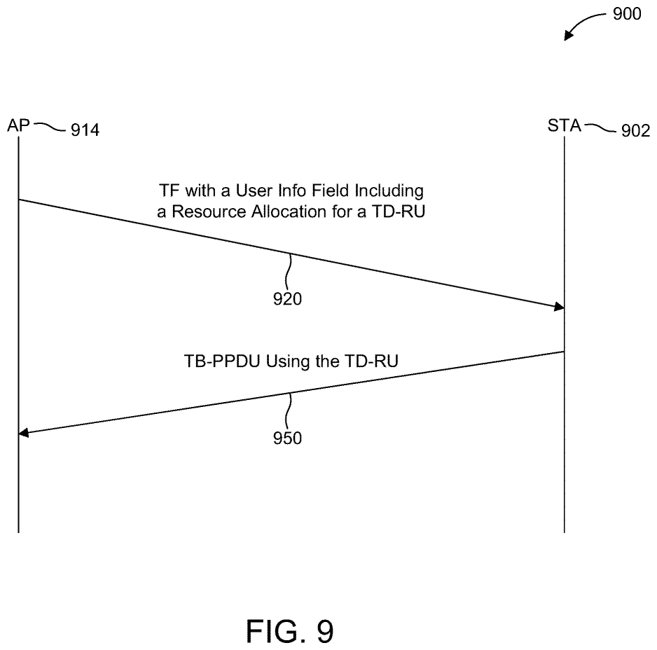

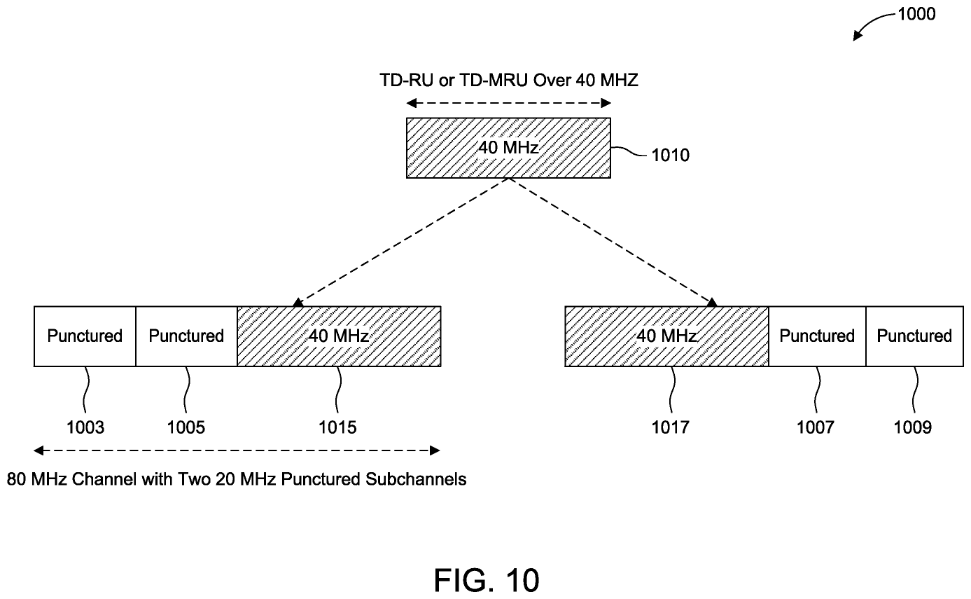

FIG. 9 is a signaling diagram illustrating an example of resource allocation for one or more TD-RUs. As shown in an example in signaling diagram 900, an AP 914 transmits a trigger frame including a user information field 920 to a STA 902. In an example, the AP 914 may be the same as, or similar to, base station 114a in FIG. 1A. Further, the STA 902 may be same as, or similar to, WTRU 102a in FIG. 1A, WTRU 102 in FIG. 1B, or both, in examples. The user information field may indicate a resource allocation for one or more TD-RUs.

The STA 902 may transmit a TD-RU transmission in the resource allocation based on the user information field indicating the resource allocation for one or more TD-RUs. Additionally or alternatively, in an example, only if the user information field includes the resource allocation for one or more TD-RUs, then may the STA 902 transmit a TD-RU transmission in the resource allocation for the one or more TD-RUs 950. In an example, the TD-RU transmission may be a TB-PPDU, and the TB-PPDU may use the TD-RUs. In a further example, the user information field may be addressed to the STA 902. Additionally or alternatively, the user information field may include an RU allocation subfield. Moreover, additionally or alternatively, the resource allocation for the one or more TD-RUs may be included in the RU allocation subfield, in an example.

Also, the user information field may include indication information indicating one or more RU/MRUs, additionally or alternatively. Additionally or alternatively, the user information field may include indication information indicating one or more TD-RUs. Further, additionally or alternatively, the indication information may further indicate a first subchannel with a first BW for at least one RU/MRU, and a second subchannel with a second BW for at least one TD-RU.

In another example, the STA may be a UHR STA, additionally or alternatively. In an additional example or an alternative example, the STA may support TD-RUs.

Examples are provided herein of methods to enable TD-RUs with puncturing. In an example, the subcarriers of a small TD-RU or TD-MRU (for example, 26-tone, 52-tone, 106-tone, 52+26-tone and 106+26-tone) may be distributed over an 80 MHz channel with one or more punctured subchannels.

In a further example, the subcarriers of a large TD-RU or TD-MRU (for example, 242-tone, 484-tone. 484+242-tone and 996-tone) may be distributed over an 80 MHz, 160 MHz, 320 MHz or wider channel with one or more punctured subchannels. In another example, the subcarriers of the small TD-RUs or TD-MRUs (for example, 26-tone, 52-tone, 106-tone, 52+26-tone and 106+26-tone) may be distributed over each 20 MHz subchannel of an 80 MHz channel individually such that the RU Allocation index or identifier of the TD-RU or TD-MRU defined for a 20 MHz may be reused with each 20 MHz subchannel of the 80 MHz channel, individually. In an example, the subcarriers of the small TD-RUs or TD-MRUs (for example, 26-tone, 52-tone, 106-tone, 52+26-tone and 106+26-tone) may be distributed over each 40 MHz subchannel of an 80 MHz channel individually such that the RU Allocation index or identifier of the TD-RU or TD-MRU defined for a 40 MHz may be reused with each 40 MHz subchannel of the 80 MHz channel.

FIG. 10 is a channel diagram illustrating an example of a distribution of TD-RUs or TD-MRUs over an 80 MHz channel with two consecutive punctured 20 MHz subchannels. As shown in an example in channel diagram 1000, the subcarriers 1010 of the small TD-RUs or TD-MRUs (for example, 26-tone, 52-tone, 106-tone, 52+26-tone and 106+26-tone) may be distributed over 40 MHz such that the subcarriers of the TD-RU or TD-MRU are mapped to the 40 MHz subchannel of an 80 MHz channel with two consecutive punctured 20 MHz subchannels. For example, the subcarriers of the TD-RU or TD-MRU may be mapped to a 40 MHz subchannel 1015 of an 80 MHz channel after two consecutive punctured 20 MHz subchannels 1003 and 1005. Additionally or alternatively, the subcarriers of the TD-RU or TD-MRU may be mapped to a 40 MHz subchannel 1017 of an 80 MHz channel before two consecutive punctured 20 MHz subchannels 1007 and 1009.

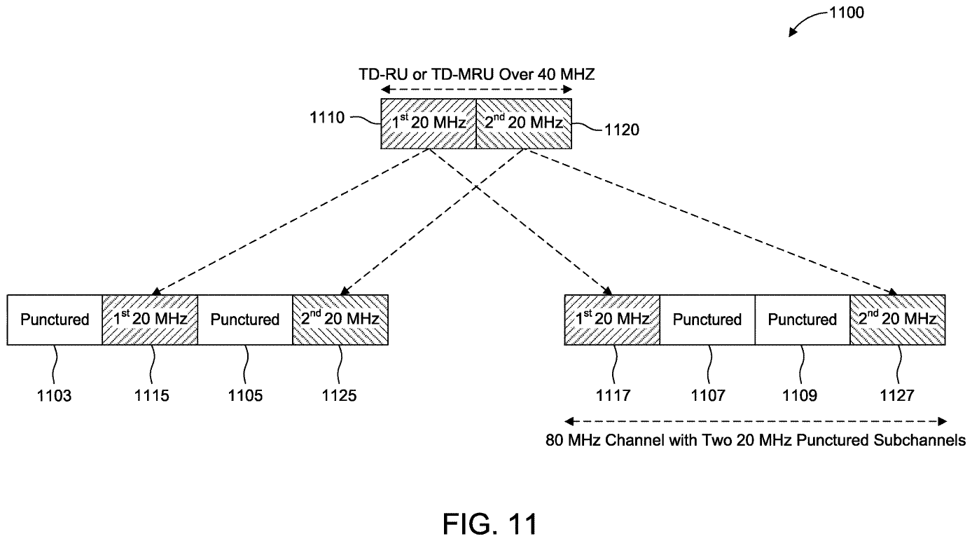

FIG. 11 is a channel diagram illustrating an example of a distribution of TD-RUs or TD-MRUs over an 80 MHz channel with two non-contiguous non-punctured 20 MHz subchannels. As shown in an example in channel diagram 1100, the subcarriers 1110, 1120 of the small TD-RUs or TD-MRUs (for example, 26-tone, 52-tone, 106-tone, 52+26-tone and 106+26-tone) may be distributed over 40 MHz such that the subcarriers of the TD-RU or TD-MRU of each 20 MHz subchannel of the 40 MHz is mapped to the corresponding 20 MHz subchannel of an 80 MHz channel with two non-contiguous, non-punctured 20 MHz subchannels. For example, the subcarriers of the TD-RU or TD-MRU may be mapped to a first non-punctured 20 MHz subchannel 1115 and a second non-punctured 20 MHz subchannel 1125 of an 80 MHz channel. Punctured 20 MHz subchannel 1103 may be mapped before non-punctured 20 MHz subchannel 1115. Also, punctured 20 MHz subchannel 1105 may be mapped after non-punctured 20 MHz subchannel 1115. Further, the non-punctured 20 MHz subchannel 1125 may be mapped after punctured 20 MHz subchannel 1105. In this way, the punctured 20 MHz subchannel 1103 and punctured 20 MHz subchannel 1105 are non-contiguous, and non-punctured 20 MHz subchannel 1115 and non-punctured 20 MHz subchannel 1125 are also non-contiguous.

Additionally or alternatively, the subcarriers of the TD-RU or TD-MRU may be mapped to a first non-punctured 20 MHz subchannel 1117 and a second non-punctured 20 MHz subchannel 1127 of an 80 MHz channel. Non-punctured punctured 20 MHz subchannel 1117 may be mapped before punctured 20 MHz subchannel 1107. Also, non-punctured 20 MHz subchannel 1127 may be mapped after punctured 20 MHz subchannel 1109. In this way, the 20 MHz subchannel 1117 and 20 MHz subchannel 1127 are non-contiguous, non-punctured subchannels.

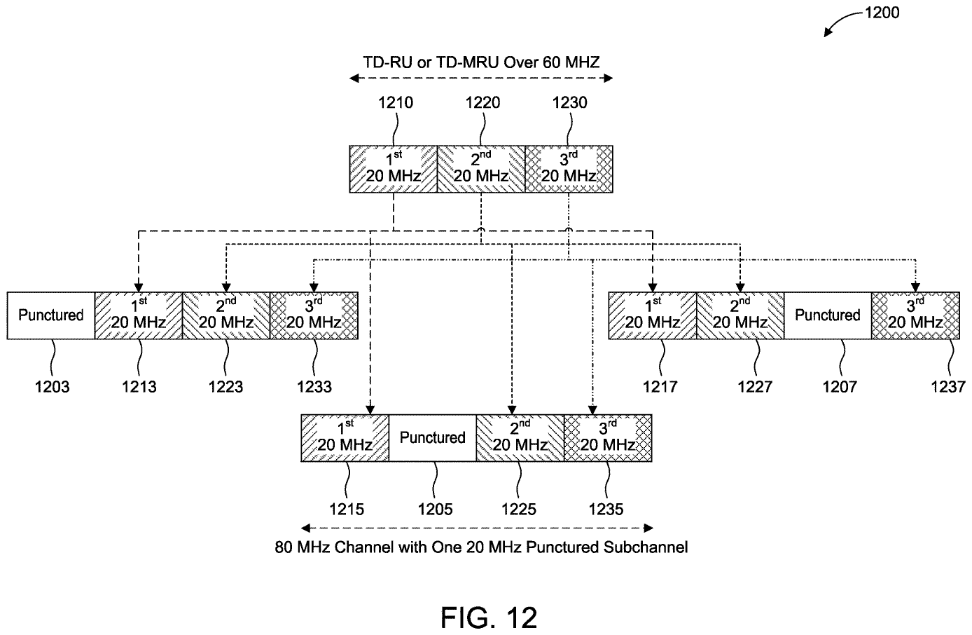

FIG. 12 is a channel diagram illustrating an example of a distribution of TD-RUs or TD-MRUs over an 80 MHz channel with one punctured 20 MHz subchannel. As shown in an example in channel diagram 1200, the subcarriers of the small TD-RUs or TD-MRUs (for example, 26-tone, 52-tone, 106-tone, 52+26-tone and 106+26-tone) may be distributed over 60 MHz such that the subcarriers of each 20 MHz of the 60 MHz are mapped to the corresponding 20 MHz subchannel 1210, 1220, 1230 of a punctured 80 MHz channel with one punctured 20 MHz subchannel.

For example, the subcarriers of the TD-RU or TD-MRU may be mapped to a first 20 MHz subchannel 1213, a second 20 MHz subchannel 1223, and a third 20 MHz subchannel 1233 of an 80 MHz channel. Punctured 20 MHz subchannel 1203 may be mapped before 20 MHz subchannel 1213.

Additionally or alternatively, the subcarriers of the TD-RU or TD-MRU may be mapped to a first 20 MHz subchannel 1215, a second 20 MHz subchannel 1225, and a third 20 MHz subchannel 1235 of an 80 MHz channel. Punctured 20 MHz subchannel 1205 may be mapped after 20 MHz subchannel 1215 and before 20 MHz subchannel 1225.

Further, additionally or alternatively, the subcarriers of the TD-RU or TD-MRU may be mapped to a first 20 MHz subchannel 1217, a second 20 MHz subchannel 1227, and a third 20 MHz subchannel 1237 of an 80 MHz channel. Punctured 20 MHz subchannel 1207 may be mapped after 20 MHz subchannel 1227 and before 20 MHz subchannel 1237.

In an example, a 242-tone TD-RU may be distributed over an 80 MHz, 160 MHz, 320 MHz, or wider channel with one 20 MHz subchannel punctured such that each sequence of subcarriers is mapped to the corresponding puncturing pattern and identified with a certain RU Allocation Index. Several examples are given in Table 5, below.

TABLE 5
Exemplary RU Allocation Index for 242-tone
TD-RU distributed over 80 MHz or 160 MHz channel
with one punctured 20 MHz Subchannel

| RU Allocation | | PPDU |
|---|---|---|
| Index | Subcarrier Indices | Bandwidth |
| 0 | List of Subcarrier Indices of 242-tone | 80 MHz |
| | TD-RU in x111 puncturing pattern | |
| 1 | List of Subcarrier Indices of 242-tone | |
| | TD-RU in 1x11 puncturing pattern | |
| 2 | List of Subcarrier Indices of 242-tone | |
| | TD-RU in 11x1 puncturing pattern | |
| 3 | List of Subcarrier Indices of 242-tone | |
| | TD-RU in 111x puncturing pattern | |
| 4 | List of Subcarrier Indices of 242-tone | 160 MHz |
| | TD-RU in x1111111 puncturing | |
| | pattern | |
| 5 | List of Subcarrier Indices of 242-tone | |
| | TD-RU in 1x111111 puncturing | |
| | pattern | |
| 6 | List of Subcarrier Indices of 242-tone | |
| | TD-RU in 11x11111 puncturing | |
| | pattern | |
| 7 | List of Subcarrier Indices of 242-tone | |
| | TD-RU in 111x1111 puncturing | |
| | pattern | |
| 8 | List of Subcarrier Indices of 242-tone | |
| | TD-RU in 1111x111 puncturing | |
| | pattern | |
| 9 | List of Subcarrier Indices of 242-tone | |
| | TD-RU in 11111x11 puncturing | |
| | pattern | |
| 10 | List of Subcarrier Indices of 242-tone | |
| | TD-RU in 111111x1 puncturing | |
| | pattern | |
| 11 | List of Subcarrier Indices of 242-tone | |
| | TD-RU in 1111111x puncturing | |
| | pattern | |

In an example, a 242-tone TD-RU may be distributed over an 80 MHz, 160 MHz, 320 MHz, or wider channel with two or more 20 MHz subchannels punctured such that each sequence of subcarriers is mapped to the corresponding puncturing pattern and identified with a certain RU Allocation Index. In a further example, a 484-tone TD-RU may be distributed over an 80 MHz, 160 MHz, 320 MHz, or wider channel with one or more 20 MHz subchannels punctured such that each sequence of subcarriers is mapped to the corresponding puncturing pattern and identified with a certain RU Allocation Index.

In another example, a 484+242-tone TD-MRU may be distributed over a 160 MHz, 320 MHz, or wider channel with one or more 20 MHz subchannels punctured such that each sequence of subcarriers is mapped to the corresponding puncturing pattern and identified with a certain RU Allocation Index. In an additional example, a 996-tone TD-RU may be distributed over a 160 MHz, 320 MHz, or wider channel with one or more 20 MHz subchannels punctured such that each sequence of subcarriers is mapped to the corresponding puncturing pattern and identified with a certain RU Allocation Index.

In an example, a 996+448-tone TD-MRU may be distributed over a 320 MHz, or wider channel with one or more 20 MHz subchannels punctured such that each sequence of subcarriers is mapped to the corresponding puncturing pattern and identified with a certain RU Allocation Index. In a further example, a 2×996-tone TD-RU may be distributed over a 320 MHz, or wider channel with one or more 20 MHz subchannels punctured such that each sequence of subcarriers is mapped to the corresponding puncturing pattern and identified with a certain RU Allocation Index.

In an example, the transmitter of a TD-RU over a punctured channel shall map the subcarriers of the TD-RU to the corresponding subcarrier indices as indicated by the RU Allocation index signaled in the SIG field of an SU or MU PPDU containing TD-RUs or the RU Allocation index signaled in the Trigger frame soliciting the transmission of a TB-PPDU containing TD-RUs. In another example, the receiver of a TD-RU over a punctured channel shall receive and decode the preamble of the SU or MU PPDU containing the TD-RUs, demap the subcarriers of the allocated TD-RU to this STA as indicated in the SIG field of the PPDU, and decode the received TD-RU accordingly.

In a further example, the receiver of a TD-RU over a punctured channel shall receive and decode the TB-PPDU containing the TD-RUs. Further, the receiver of the TD-RU shall demap the subcarriers of the received TD-RU from the transmitting STA as signaled in the Trigger frame soliciting the TB-PPDU, and decode the received TD-RU accordingly.

In an additional example, the AP shall allocate TD-RUs or TD-MRUs to a STA with limited capability (such as 20 MHz-only STAs) that are distributed over the limited bandwidth of this STA. In one example, a 20 MHz-only STA shall be allocated a TD-RU or a TD-MRU that has a TD-RU bandwidth (the bandwidth over which the TD-RU or the TD-MRU is distributed) of 20 MHz. In another example, an 80 MHz-only STA shall be allocated a TD-RU or a TD-MRU that has a TD-RU Bandwidth of 80 MHz or less.

Although the features and elements of the present invention are described in the preferred embodiments in particular combinations, each feature or element can be used alone without the other features and elements of the preferred embodiments or in various combinations with or without other features and elements of the present invention. Although one or more solutions described herein consider 802.11 specific protocols, it is understood that the solutions described herein are not restricted to this scenario and are applicable to other wireless systems as well. Although short interframe spacing (SIFS) may be used to indicate various inter frame spacing in one or more of the examples of the designs and procedures, all other inter frame spacing such as reduced interframe spacing (RIFS), arbitrary interframe spacing AIFS, distributed coordination function (DCF) interframe spacing DIFS or other agreed time interval could be applied in the same solutions or similar solutions.

Although four resource blocks (RBs) per triggered transmission opportunity (TXOP) may be shown in some figures as an example, the actual number of RBs/channels/bandwidth utilized may vary. Long Training Field (LTF) may be any type of predefined sequences that are known at both the transmitter and receiver sides.

Several or many procedures may be explained from the AP point of view, however these procedures equally applies from the non-AP STA point of view. Many procedures are explained for TD-RUs, however these procedures equally apply for TD-MRUs. Some signaling fields and subfields are set to 1 or 0 to signal a given indication in examples provided herein, but the same concepts may use any other setting of the subfields to signal the same indication.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, STA, AP, base station, MLD, RNC, or any host computer.

1. A method for use in a station (STA), the method comprising:
receiving a trigger frame including a common information field and a user information field, wherein the common information field includes first indication information indicating a tone distributed resource unit (TD-RU), wherein the user information field includes second indication information indicating a resource allocation for the TD-RU, wherein the resource allocation for the TD-RU indicates subcarriers, including a punctured channel, mapped to corresponding subcarrier indices; and
transmitting a TD-RU transmission in the subcarriers, including the punctured channel, indicated by the resource allocation for the TD-RU indicated by the second indication information.

2. The method of claim 1, wherein the TD-RU transmission is a trigger based (TB) physical layer (PHY) protocol data unit (PDU) (TB-PPDU).

3. The method of claim 1, wherein the user information field is addressed to the STA.

4. The method of claim 1, wherein the user information field includes an RU allocation subfield, and the resource allocation for the TD-RU is included within the RU allocation subfield.

5. The method of claim 1, wherein the STA is an ultra high reliability (UHR) STA.

6. The method of claim 1, wherein the STA supports TD-RUs.

7. The method of claim 1, wherein the TD-RU is a resource unit whose subcarriers are spread over a certain bandwidth which is larger than the bandwidth effectively occupied by this resource unit.

8. (canceled)

9. (canceled)

10. A station (STA) comprising:
a transceiver; and
a processor operatively coupled to the transceiver; wherein:
the transceiver is configured to receive a trigger frame including a common information field and a user information field, wherein the common information field includes first indication information indicating a tone distributed resource unit (TD-RU), wherein the user information field includes second indication information indicating a resource allocation for the TD-RU, wherein the resource allocation for the TD-RU indicates subcarriers, including a punctured channel, mapped to corresponding subcarrier indices; and
the transceiver and the processor are configured to transmit a TD-RU transmission in the subcarriers, including the punctured channel, indicated by the resource allocation for the TD-RU indicated by the second indication information.

11. The STA of claim 10, wherein the TD-RU transmission is a trigger based (TB) physical layer (PHY) protocol data unit (PDU) (TB-PPDU).

12. The STA of claim 10, wherein the user information field is addressed to the STA.

13. The STA of claim 10, wherein the user information field includes an RU allocation subfield, and the resource allocation for the TD-RU is included within the RU allocation subfield.

14. The STA of claim 10, wherein the STA is an ultra high reliability (UHR) STA.

15. The STA of claim 10, wherein the STA supports TD-RUs.

16. The STA of claim 10, wherein the TD-RU is a resource unit whose subcarriers are spread over a certain bandwidth which is larger than the bandwidth effectively occupied by this resource unit.

17. (canceled)

18. (canceled)
